(19) United States
(12) Patent Application Publication
(10) Pub. No.: US 2004/0033854 A1
(43) Pub. Date: Feb. 19, 2004

(54) Drive chain

(76) Inventor: Daniel Wu, Tainan City (TW)

Correspondence Address: HARNESS, DICKEY & PIERCE, P.L.C., P.O. BOX 8910, RESTON, VA, 20195, US

(21) Appl. No.: 10/219,316

(22) Filed: Aug. 16, 2002

(51) Int. Cl. F16G 13/02; F16G 15/00

(52) U.S. Cl. 474/231; 474/223

(57) ABSTRACT

A plurality of chain components of a drive chain include a plurality of pairs of outer chain plates, a plurality of pairs of inner chain plates, a plurality of tubular rollers, and a plurality of pins. At least one of the outer chain plates, the inner chain plates and the tubular rollers has a hardened layer formed by infiltrating with at least one element selected from boron, chromium and aluminum.

### BACKGROUND OF THE INVENTION

1. Field of the Invention

The invention relates to a drive chain, more particularly to a drive chain having chain components provided with a hardened layer so as to obtain advantages such as enhanced hardness, abrasion resistance, rust prevention, and durability.

2. Description of the Related Art

A conventional drive chain usually includes a plurality of chain components and an end-chain-component-connecting unit. The chain components include a plurality of parallel pairs of inner chain plates, a plurality of parallel pairs of outer chain plates, a plurality of pins, a plurality of bushings, and a plurality of tubular rollers. The end-chain-component-connecting unit includes a pair of connecting plates, two connecting pins, and an anchoring plate.

Since the pivot joints among the inner and outer chain plates and the pins of the drive chain are exposed, dirt can easily get trapped and collect in clearances that are formed by the pivot joints, which would result in abrasion of the components during pivoting movement among the components of the drive chain. Therefore, it is desired in the art to enhance abrasion resistance of the components of the drive chain, and to increase safety and durability of the drive chain by periodic maintenance.

It is well known in the art to infiltrate the components of the drive chain with carbon so as to enhance the hardness and the abrasion resistance of the drive chain components. However, since the rust prevention capability of the drive chain is inferior, it is therefore required to treat the surfaces of the components of the drive chain by electroplating. The plating layer of the drive chain components is liable to abraded and stripped after a period of operation, which would degrade the rust prevention capability of the drive chain. Alternatively, the conventional drive chain may be made of stainless steel so as to enhance the rust prevention capability thereof. However, stainless steel chain components suffer from the shortcomings such as inferior hardness and abrasion resistance, and increased cost. Furthermore, it is required to frequently maintain the drive chain by using cleaning agents and lubricating oil. This would further increase the cost and result in more inconvenience in use.

### SUMMARY OF THE INVENTION

Therefore, the object of the present invention is to provide a drive chain having chain components provided with a hardened layer so as to overcome the aforesaid drawbacks commonly associated with the prior art.

Accordingly, the drive chain of this invention includes:

a plurality of parallel pairs of outer chain plates;

a plurality of parallel pairs of inner chain plates, each pair of the inner chain plates being disposed between two adjacent pairs of the outer chain plates;

a plurality of tubular rollers, each disposed between one pair of the inner chain plates; and

a plurality of pins extending respectively and axially through the rollers and connecting the inner chain plates to the outer chain plates, respectively.

At least one of the outer chain plates, the inner chain plates, and the tubular rollers has a hardened layer formed by infiltrating with at least one element selected from the group consisting of boron, chromium and aluminum.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary partly cross-sectional schematic view of the preferred embodiment of the drive chain according to this invention;

FIG. 2 is a fragmentary side view of the preferred embodiment of the drive chain according to this invention; and

FIG. 3 is a fragmentary partly cross-sectional enlarged view of the preferred embodiment of the drive chain according to this invention.

### DETAILED DESCRIPTION OF THE PREFERRED EMBODIMENTS

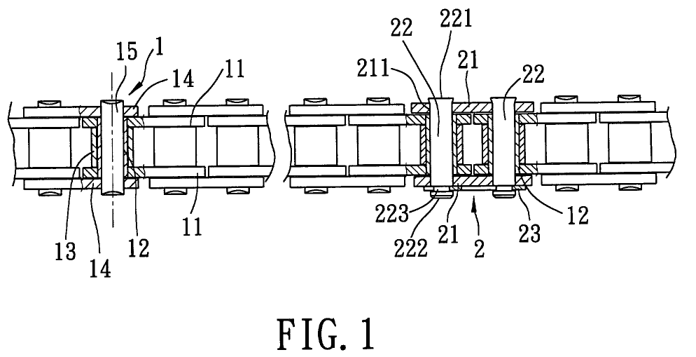

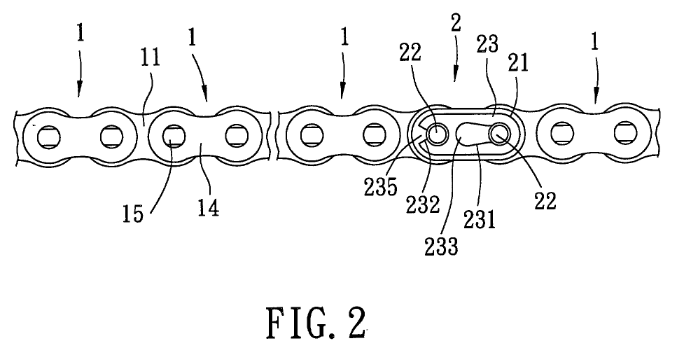

Referring to FIGS. 1 and 2, the preferred embodiment of the drive chain according to this invention is shown to include a plurality of chain components 1 and an end-chain-component connecting unit 2. The plurality of chain components 1 include a plurality of parallel pairs of outer chain plates 14, a plurality of parallel pairs of inner chain plates 11, a plurality of tubular rollers 13, a plurality of pins 15, and a plurality of bushings 12. Each pair of the inner chain plates 11 is disposed between two adjacent pairs of the outer chain plates 14. Each of the tubular rollers 13 is disposed between one pair of the inner chain plates 11. The pins 15 extend respectively and axially through the rollers 13 and connect the inner chain plates 11 to the outer chain plates 14, respectively. Each of the bushings 12 is sleeved on a respective one of the pins 15 within a respective one of the rollers 13.

The end-chain-component-connecting unit 2 includes a pair of connecting plates 21, two connecting pins 22, and an anchoring plate 23. The connecting plates 21 are substantially identical to the outer chain plates 14. Each of the connecting pins 22 extends axially through one of the bushings 12 and through the corresponding pin holes 211 in the connecting plates 21, and connects two of the inner chain plates 11 to the connecting plates 21. Each of the connecting pins 22 has a flange end 221 and an anchoring end 222 formed with a recessed neck 223.

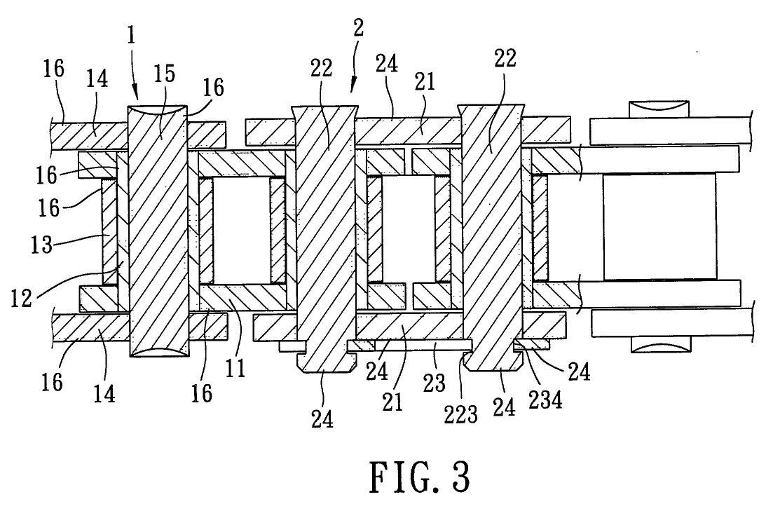

Referring to FIGS. 2 and 3, the anchoring plate 23 is anchored onto the recessed necks 223 of the connecting pins 22 so as to form the drive chain into a loop. The anchoring plate 23 is formed with a closed anchoring hole 231 and an open anchoring hole 232. The closed anchoring hole 231 has an inserting portion 233 with a diameter larger than that of the anchoring end 222 of the connecting pin 22, and an anchoring portion 234 with a diameter corresponding to that of the recessed neck 223 of the connecting pin 22. The open anchoring hole 232 has a diameter identical to that of the anchoring portion 234 of the closed anchoring hole 231, and an open end 235 distal from the closed anchoring hole 231.

When assembling the end-chain-component-connecting unit 2, the anchoring end 222 of one of the connecting pins 22 is inserted through the inserting portion 233 of the closed anchoring hole 231. The anchoring plate 23 is then moved so as to anchor the recessed neck 223 of said one of the connecting pins 22 within the anchoring portion 234 of the closed anchoring hole 231. At the same time, the recessed neck 223 of the other one of the connecting pins 22 is anchored within the open anchoring hole 232 through the open end 235 of the open anchoring hole 232.

In this embodiment, each of the outer chain plates 14, the inner chain plates 11 and the tubular rollers 13 is formed with a hardened layer 16. Preferably, each of the pins 15 and the bushings 12 is also formed with a hardened layer 16. Each component of the end-chain-component-connecting unit 2, i.e. the connecting plates 21, the connecting pins 22, and the anchoring plate 23, is also formed with a hardened layer 24. The hardened layers 16, 24 are formed by infiltrating the chain components 1 and those of the end-chain-component-connecting unit 2 with at least one element selected from the group consisting of boron, chromium and aluminum.

In the infiltrating treatment with chromium, the components of the drive chain to be treated are heated in a chromium infiltration reactor together with chromium or chromium-iron alloy with low carbon content, aluminum oxide and ammonium chloride so as to infiltrate chromium into the components of the drive chain and to form the hardened layers 16, 24. The thickness of each of the hardened layers 16, 24 preferably ranges from 0.05 mm to 0.15 mm. Since the hardened layers 16, 24 thus formed have superior properties such as acid resistance, hardness and abrasion resistance, the components of the drive chain formed with the hardened layer 16, 24 have superior properties such as abrasion resistance and rust prevention.

In the infiltrating treatment with boron, the method for the infiltrating treatment with boron includes gas boronization, molten bath hydrolysis, salt bath immersion, solution boronization, solid boronization, etc.

Furthermore, the hardened layers 16, 24 can be formed by infiltrating the components of the drive chain with one or more of chromium, boron and aluminum.

It is apparent from the foregoing that the components of the drive chain according to this invention are formed with hardened layers so as to enhance the properties such as hardness, abrasion resistance, rust prevention, and durability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A drive chain comprising:
a plurality of parallel pairs of outer chain plates;
a plurality of parallel pairs of inner chain plates, each pair of said inner chain plates being disposed between two adjacent pairs of said outer chain plates;
a plurality of tubular rollers, each disposed between one pair of said inner chain plates; and
a plurality of pins extending respectively and axially through said rollers and connecting said inner chain plates to said outer chain plates, respectively;
wherein at least one of said outer chain plates, said inner chain plates, and said tubular rollers has a hardened layer formed by infiltrating said at least one of said outer chain plates, said inner chain plates, and said tubular rollers with at least one element selected from the group consisting of boron, chromium and aluminum.

2. The drive chain as claimed in claim 1, further comprising a plurality of bushings, each of which is sleeved on a respective one of said pins within a respective one of said rollers, at least one of said pins and said bushings having a hardened layer formed by infiltrating said at least one of said pins and said bushings with at least one element selected from the group consisting of boron, chromium and aluminum.
